(19) United States
(12) Patent Application Publication
(10) Pub. No.: US 2011/0097926 A1
(43) Pub. Date: Apr. 28, 2011

(54) ELECTRICAL SOCKET AND METHOD OF USE THEREOF

(75) Inventor: David Bowen, West Yorkshire (GB)

(73) Assignee: LOGICOR LIMITED, WAKEFIELD (GB)

(21) Appl. No.: 12/992,402

(22) PCT Filed: May 12, 2009
(86) PCT No.: PCT/GB09/01180

§ 371 Date: Jan. 11, 2011

(30) Foreign Application Priority Data
May 15, 2008 (GB) 0808796.7

(51) Int. Cl. H01R 13/70; H01R 3/00

(52) U.S. Cl. 439/488; 439/620.01

(57) ABSTRACT

An electrical wall socket is provided including a housing having one or more electrical socket connection means defined thereon to allow engagement with at least one electrical plug therewith in use. The wall socket is provided with timing means for timing or determining one or more pre-determined time periods. The timing means are arranged such that when actuated, the timing means allow electrical current to flow through said electrical socket from an electrical supply and/or from said electrical socket connection means to an electrical plug engaged therewith in use for said one or more pre-determined time periods.

This invention relates to an electrical socket and a method of use thereof.

Although the following description refers almost exclusively to an electrical socket in the form of a three pin electrical socket of a type commonly used in the United Kingdom, it will be appreciated by persons skilled in the art that the present invention can relate to any type of electrical socket, such as a two pin socket, single pin socket and/or the like, or indeed any type of electrical socket in which a complementary plug or connection can be inserted or engaged therewith to allow the flow of electrical charge between the socket and the plug or complementary connection.

Conventionally if a user wishes to use an electrical appliance, such as for example an iron, the user locates the plug, typically attached to the iron at the end of an electrical cable running between the iron housing and the plug, in a wall electrical socket. The user then actuates a switch associated with the wall socket to allow electrical current to pass from a mains power supply, through the wall socket, along the plug pins to electrical connections internally of the plug and along the electrical cable to the iron. A further operational switch may be associated with the iron to allow the electrical current being passed along the electrical cable to make contact with electrical connections in the iron if required. Once the user has finished with the iron, the user may switch the iron off by operating the iron operational switch, the wall socket switch and/or removing the plug from the wall socket, thereby stopping the flow of electrical current from the mains power supply to the iron.

However, a common problem is that a user may forget to switch the iron or other electrical appliance off after use, particularly if the user is a child or elderly person. This can lead to a waste of electrical power and/or over heating of the appliance, which may result in fire and/or damage to the appliance or locality in which the appliance is located.

In an attempt to overcome this problem, it is known to provide timing devices which automatically switch the electricity supply to an appliance on and/or off after one or more pre-determined time periods. An example of such a timing device typically requires a user to first set the timing device to switch the electrical supply on at a first set time and to switch the electrical supply off at a second set time. This setting may require use of a tool. The timing device is then plugged into a wall socket and the electrical appliance is plugged into the timing device. However, it can be time consuming and fiddly to set/reset the timing device and the timing device may not be set to function when the user wishes to use the appliance. As such, a user will often not use the timing device. In addition, the combination of a separate timing device and plug makes the arrangement bulky and unsightly.

A further example of a timing device is disclosed in the applicant's co-pending patent application PCT/GB2007/003786. The timing device is in the form of an electrical plug comprising a plug housing having first and second parts. Electrical pins are provided on one of the parts of the plug housing to allow electricity to flow from an electrical socket, with which the plug is engaged with in use, to the electrical pins. A movement mechanism is provided in the plug housing which is arranged to allow relative movement of the plug parts between a first position, wherein electrical charge can flow therebetween, and a second position, wherein the flow of electrical charge is prevented. The relative movement of the plug parts takes place over a pre-determined time period following actuation of the same. A problem with the abovementioned timing device is that a timing device is required to be provided with each item of electrical apparatus for which timed use is desired.

It is therefore an aim of the present invention to provide an electrical socket which overcomes the abovementioned problem.

It is therefore a further aim of the present invention to provide a method of use of an electrical socket which overcomes the abovementioned problem.

According to a first aspect of the present invention there is provided an electrical wall socket, said wall socket including a housing having one or more electrical socket connection means defined thereon to allow engagement with at least one electrical plug therewith in use, and wherein said wall socket is provided with timing means for timing or determining one or more pre-determined time periods, said timing means arranged such that when actuated, the timing means allows electrical current to flow through said electrical socket from an electrical supply and/or from said electrical socket connection means to an electrical plug engaged therewith in use for said one or more pre-determined time periods.

Once the timing means has been actuated, it allows operation of the electrical socket for said one or more pre-determined time periods without further user actuation or intervention being required and, once said time period has expired, the timing means automatically moves the socket to an un-operational condition until further actuation of the timing means takes place.

The timing means can be manually actuated by a user. Alternatively, the timing means can be actuated remotely from the wall socket via remote control means.

An electrical supply is typically connected to the electrical wall socket in use, such as a mains electrical supply, and said electrical supply is arranged to flow to said electrical socket connection means in normal operation (i.e. during said one or more pre-determined time periods).

In one embodiment the timing means are associated with, are provided on or form part of the electrical socket connection means.

In one embodiment electrical control means are provided on the electrical wall socket, such as an electrical on/off switch for example, and said timing means are associated with, provided on or form part of the electrical control means. The electrical control means typically control the flow of electrical current from an electrical supply to the electrical socket and/or socket connection means.

In a further embodiment the timing means can be provided on, associated with or form part of the housing of said electrical socket (i.e. separate to the electrical socket connection means and electrical control means).

Thus, the present invention provides an electrical socket, such as for example an electrical wall socket, with timing means to allow electricity to flow for a pre-determined period of time instead of or in addition to timing means which may be associated with the electrical plug or an electrical adaptor which is located with the electrical socket in use. This has the advantage that any item of electrical apparatus can be used with the electrical socket without requiring separate timing means to be provided with the electrical apparatus or plug associated with the electrical apparatus.

According to a second aspect of the present invention there is provided an electrical socket, said electrical socket including a housing having one or more electrical socket connection means provided thereon to allow engagement with at least one electrical plug therewith in use, and wherein said electrical socket is provided with timing means for timing or determining one or more pre-determined time periods for which electrical current can flow through said electrical socket, and wherein said timing means are provided on, associated with or form part of the electrical socket connection means and/or said one or more electrical control means or switches provided with the socket. In this embodiment the electrical socket does not necessarily have to be a wall mounted socket. Thus, for example, the electrical socket can be provided on any suitable surface, such as on an electrical generator, an electrical extension unit and/or the like. Preferably the timing means are arranged such that when actuated, the timing means allows electrical current to flow from said electrical socket connection means to an electrical plug engaged therewith for a pre-determined period of time.

Preferably the timing means associated with either the electrical socket connection means, the electrical control means and/or some other part of the electrical socket includes at least a first part and a second part. At least one of said parts is capable of undergoing relative movement with respect to the other part between a first position, wherein electrical connection can be made between an electrical supply, the electrical socket connection means and/or an electrical plug engaged with the electrical connection means, and a second position, wherein electrical connection between an electrical supply, the electrical socket connection means and/or an electrical plug engaged with the electrical connection means is prevented.

It will be appreciated that both the at least first and second parts can be capable of undergoing relative movement or one of the parts can be substantially fixed and the other part moves relative to said fixed part.

Preferably the second part is slidably movable relative to said first part in moving between said first and second positions.

In one embodiment the second part is at least partially slidably mounted in a recess or aperture defined in said first part or housing.

Further preferably the second part is slidably movable outwardly of said electrical socket in moving between said first position to said second position (i.e. towards a front surface of the socket housing or away from a rear surface of the socket housing). A whole or section of the second part can protrude outwardly from a front surface of the housing in the second position or the movement of the second part can take place substantially wholly within the socket housing. On actuation of the timing means, a user depresses the second part inwardly of the housing or first part to achieve the first position. The user may be required to depress the second part such that substantially all the second part is recessed within the housing or first part, or is more recessed with respect to the housing or first part in the first position compared to the second position.

In one embodiment the second part is arranged to move in a direction substantially perpendicular to the front surface of the electrical socket housing. For example, the second part can be movable in a substantially horizontal direction. Movement of the second part is preferably reciprocal and/or substantially linear movement with respect to the first part or housing in moving between said first and second positions.

Preferably movement means are provided with or associated with the first and/or second parts or timing means to allow movement of at least one part relative to the other part. The movement means can include or comprise any or any combination of biasing means, resilient biasing means, such as a compressed spring and/or the like, pneumatic means, hydraulic means, mechanical means and/or the like. The biasing means typically biases the timing means to a non-operational position.

Preferably biasing means are provided with the socket for biasing the second part from the second position to the first position. The biasing means can include any or any combination of resilient biasing means, such as a compressed spring and/or the like, pneumatic means, hydraulic means, mechanical means and/or the like.

At least one of the first and second parts is in the form of a channel member, sleeve member or housing, the other part is slidably mounted or movable therein, on or around the other housing, channel or sleeve member. Preferably at least a portion of the second part is telescopically mounted in a recess or aperture defined in said first part.

In one embodiment the first part is integral with, detachably attached or attached to the socket housing.

The second part is typically formed such that in the first or second positions, user access to the interior of the electrical socket or electrical pins of the plug engaged with the electrical socket is prevented. This prevents any electrical connections from being exposed when electrical current is flowing through the same in use.

The amount of movement or speed of movement of the movement means, timing means, biasing means and/or the second part relative to the first part between the first and second positions typically defines or determines the one or more pre-determined time periods of the timing means for which electrical current can flow. The timing means can be an actual timing device or can be as a result of the inherent timing of movement of a component when actuated, such as the uncoiling of a compressed spring, the conversion of potential energy to kinetic energy, the movement of air within a chamber and/or the like.

In one embodiment the pre-determined time period for which electrical current is supplied can be pre-set by a manufacturer or can be selected by a user. For example, one or more user selectable pre-determined time periods can be provided for the user to select or the user can arbitrarily select a time period. The one or more time periods can be set on the electrical socket via timing adjustment means. The timing adjustment means could be accessible from an external surface of the electrical socket or internal access to the electrical socket may be required for adjustment of the same. Alternatively, the one or more pre-determined time periods could be set remotely from processing means associated with the socket using remote control means.

In one example, timer adjustment means includes an adjustment screw which is accessible to a user. Adjustment of the screw (i.e. by rotation of the same) allows adjustment of the movement means and/or biasing means to adjust said one or more pre-determined time periods. The adjustment screw is preferably accessible via an aperture defined in a front, side or end wall of the socket housing.

In one embodiment, a pre-determined period of time needs to pass before the timing means on the electrical socket can be re-actuated after use thereof.

One of more electrical contacts can be provided with, comprise or be associated with the first and/or second parts such that in the first position electrical current can flow between the electrical contacts to allow electrical current to flow between an electrical supply, the electrical socket, the electrical socket connection means and/or an electrical plug. In the second position electrical connection between the contacts is broken or electrical flow is prevented. Alternatively, one or more electrical contacts can be located separate to but preferably adjacent the first and/or second parts and movement of the first and/or second parts simply moves the electrical contacts associated with the electrical socket and/or plug between an engaged or operational condition and a disengaged position or non-operational condition.

According to a further independent aspect of the present invention there is provided an electrical socket wherein the electrical socket connection means are provided with timing means and said timing means are arranged such that when actuated, the timing means allows electrical current to flow from said electrical socket connection means to an electrical plug engaged therewith for a pre-determined period of time.

According to a yet further independent aspect of the present invention there is provided an electrical socket wherein the electrical socket control means are provided with timing means and said timing means are arranged such that when actuated, the timing means allows electrical current to flow from an electrical supply to said electrical socket connection means for a pre-determined period of time.

In any of the above described embodiments, the electrical socket connection means are arranged such that when one or more electrical pins or electrical connection means provided on an electrical plug are moved into engagement with the electrical socket connection means, electrical current is capable of flowing from an electrical supply, through said electrical socket connection means, through said one or more electrical pins or electrical plug connection means and into electrical apparatus associated with said one or more electrical pins or electrical plug connection means.

In one embodiment an electrical cable is provided between the electrical pins or electrical plug connection means and the item of electrical apparatus. Electrical current flows along the electrical cable from the electrical pins or electrical plug connection means to the electrical apparatus in use.

Preferably the one or more electrical control means or switches provided on the electrical socket allows the flow of electrical current to the electrical socket connection means to be switched or moved between on and off conditions. Further preferably the control means are in the form of an on/off switch, button, dial and/or the like. The electrical control means can be moved in an appropriate manner, such as in a slidable, pivotable, rotatable, depressable and/or the like manner to move the control means between the on and off conditions. For example, the switch can be a conventional pivotable type of switch, can be a depressable button and/or the like.

With the electrical control means in the “on” condition, electrical current can flow from an electrical supply, such as a mains electrical supply to the electrical socket connection means. With the electrical control means in the “off” condition, electrical current is prevented from flowing from the electrical supply to the electrical socket connection means.

In the embodiment where the timing means are provided with the socket connection means, if electrical control means are provided on the socket (and it is not an essential requirement) the control means have to be in an “on” condition and the timing means associated with the socket connection means have to be actuated before electrical current will flow from said electrical socket to an electrical plug connected therewith in use. If the control means are in an “off” condition, electrical current is typically prevented from flowing, even if the timing means associated with the socket connection means has been actuated.

In this embodiment operational means can be associated with the timing means provided with the electrical socket connection means to allow the timing means to be moved between operational and non-operational conditions. With the timing means in the non-operational condition, the electrical socket can be used in a conventional manner without timed use. With the timing means in the operational condition, the timing means can work as described above.

In this embodiment, the second part typically includes one or more apertures or recesses for engaging with one or more electrical pins or connections provided on the electrical plug in use. The apertures or recesses are typically substantially complementary to the electrical pins or connections on the plug.

In this embodiment, preferably actuation of the movement means and/or timing means takes place on engagement of an electrical plug into the electrical socket connection means. Further actuation may be required by actuating electrical control means associated with the electrical socket and/or applying a further movement force to the electrical plug relative to the electrical socket (i.e. to allow movement of the second part from the second position to the first position). For example, actuation of the timing means could be a two-step process; a first step could involve location of the plug with the second part and the second step could include moving the second part and plug relative to the first part or housing.

In the embodiment where the timing means are provided with the electrical control means of the socket, a conventional plug can be located in the electrical socket connection means and the control means of the socket are actuated by moving the same from an “off” condition to an “on” condition.

According to a further aspect of the present invention there is provided a method of using an electrical socket with timing means.

According to a yet further aspect of the present invention there is provided a method of using an electrical wall socket, said method including the steps of engaging an electrical plug with electrical socket connection means defined on said wall socket, and actuating timing means provided on said wall socket for timing or determining one or more pre-determined time periods, said timing means arranged such that when actuated, the timing means allows electrical current to flow through said electrical socket from an electrical supply and/or from said electrical socket connection means to the electrical plug engaged therewith for said one or more pre-determined time periods.

Written instruction, symbols, arrows and/or the like can be provided on the wall socket to allow a user to determine how to use the same. For example, one or more arrows can be provided on the exterior of the wall socket housing to show a user the correct direction they are required to push in order to actuate the timing means.

In one example, the uncoiling of a spring or resilient biasing means could determine the pre-determined time period.

Embodiments of the present invention will now be described with reference to the accompanying figures, wherein:

FIG. 1a is a perspective view of an electrical socket according to one embodiment of the present invention in use;

FIG. 1b is a schematic view of the electrical connection of the embodiment in FIG. 1a;

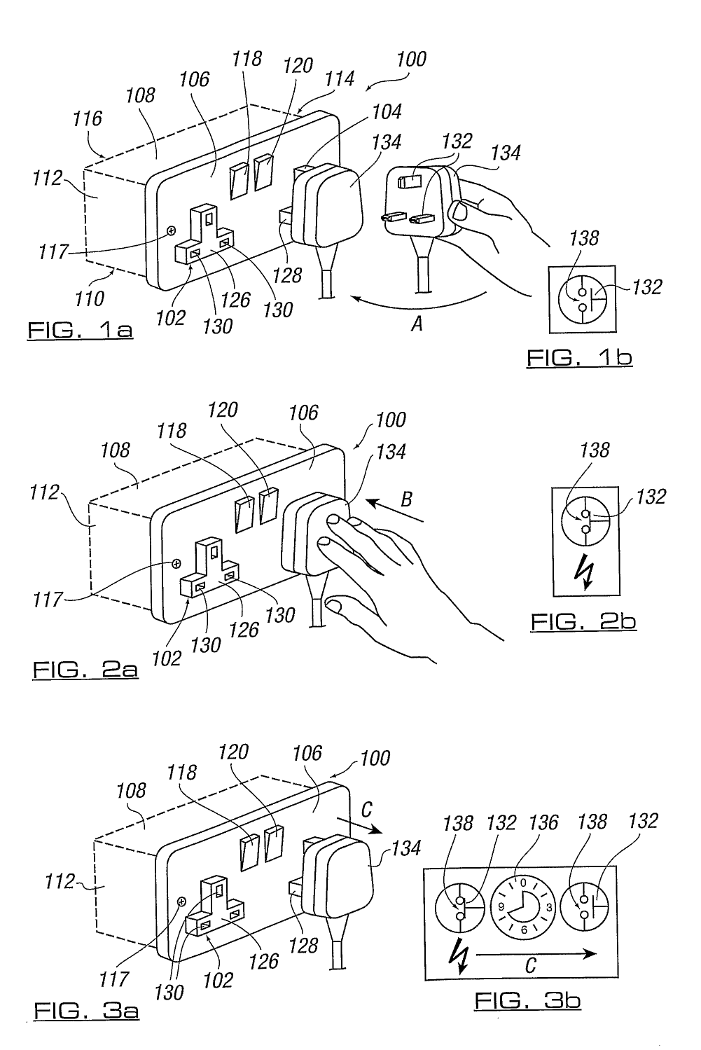

FIG. 2a is a perspective view of the electrical socket in FIG. 1a in an actuated position;

FIG. 2b is a schematic view of the electrical connection of the embodiment in FIG. 2a;

FIG. 3a is a perspective view of the electrical socket in FIG. 2a following actuation;

FIG. 3b is a schematic view of the electrical connection of the embodiment in FIG. 3a;

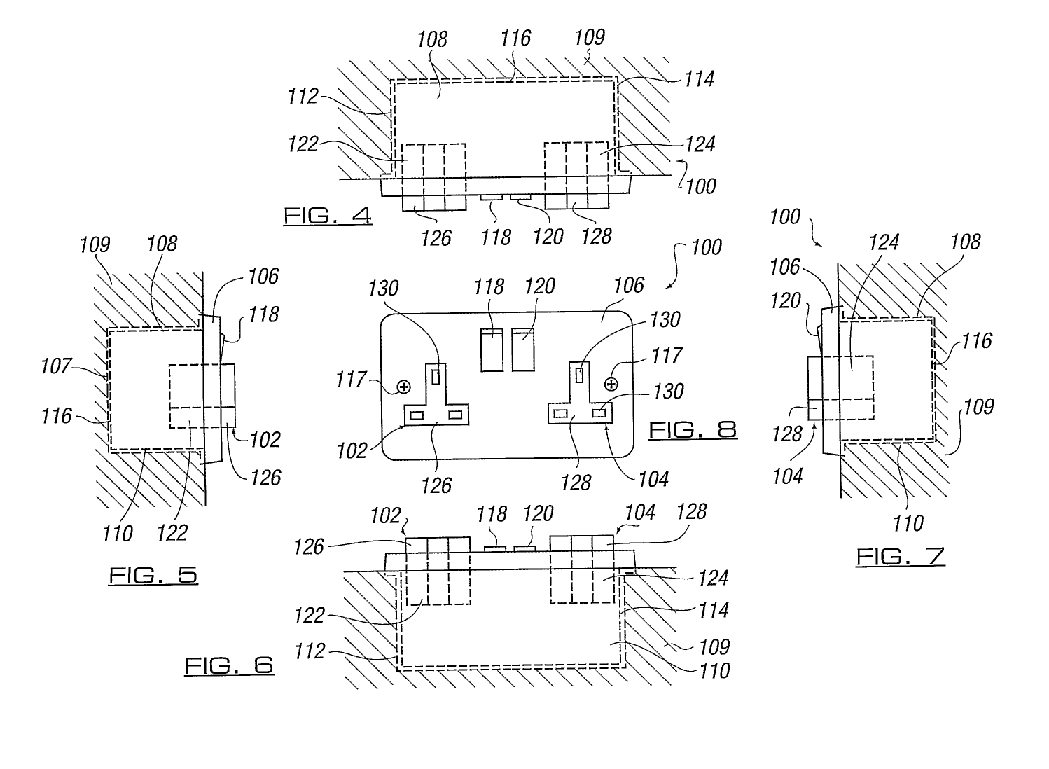

FIGS. 4-8 illustrate a cross sectional view of the electrical socket in FIG. 1a from the top, left side, right side and base and a front view respectively;

FIG. 9a illustrates a cross sectional view of the side of the electrical socket in FIG. 1a with an electrical plug partially engaged therewith in use;

FIG. 9b is a schematic view of the electrical connection of the embodiment in FIG. 9a;

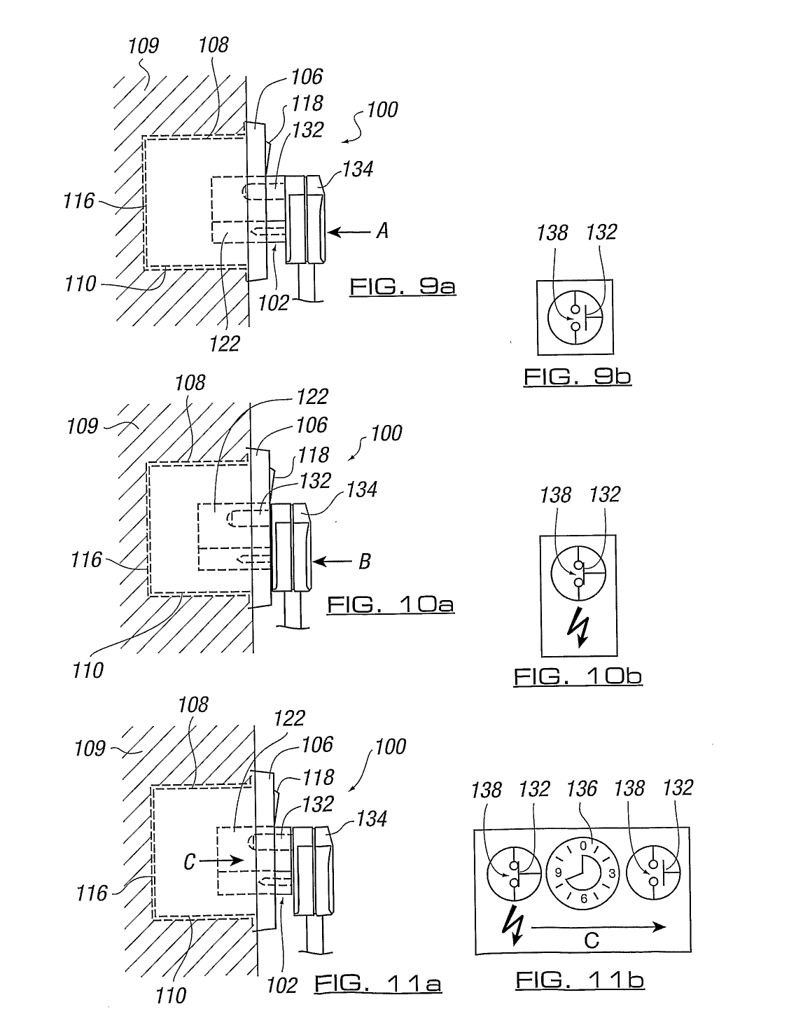

FIG. 10a illustrates a cross sectional view of the side of the electrical socket in FIG. 2a with an electrical plug in an actuated position;

FIG. 10b is a schematic view of the electrical connection of the embodiment in FIG. 10a;

FIG. 11a illustrates a cross sectional view of the side of the electrical socket in FIG. 3a with the electrical plug partially engaged therewith following actuation;

FIG. 11b is a schematic view of the electrical connection of the embodiment in FIG. 11a;

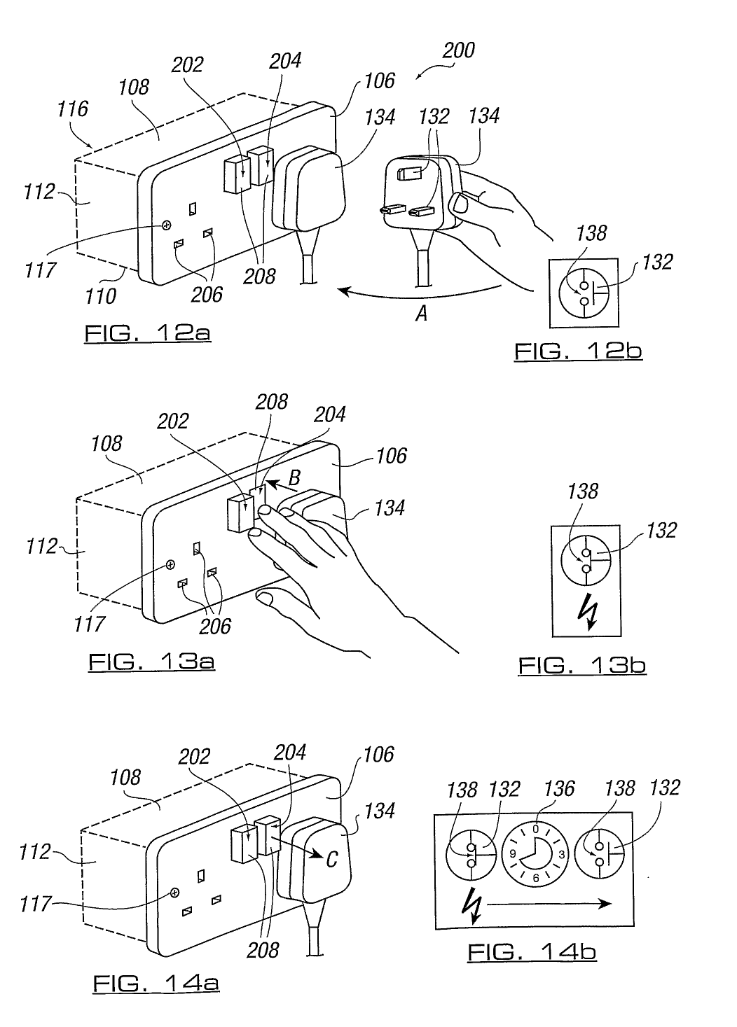

FIG. 12a is a perspective view of an electrical socket according to a further embodiment of the present invention in use;

FIG. 12b is a schematic view of the electrical connection of the embodiment in FIG. 12a;

FIG. 13a is a perspective view of the electrical socket in FIG. 12a in an actuated position;

FIG. 13b is a schematic view of the electrical connection of the embodiment in FIG. 13a;

FIG. 14a is a perspective view of the electrical socket in FIG. 13a following actuation;

FIG. 14b is a schematic view of the electrical connection of the embodiment in FIG. 14a;

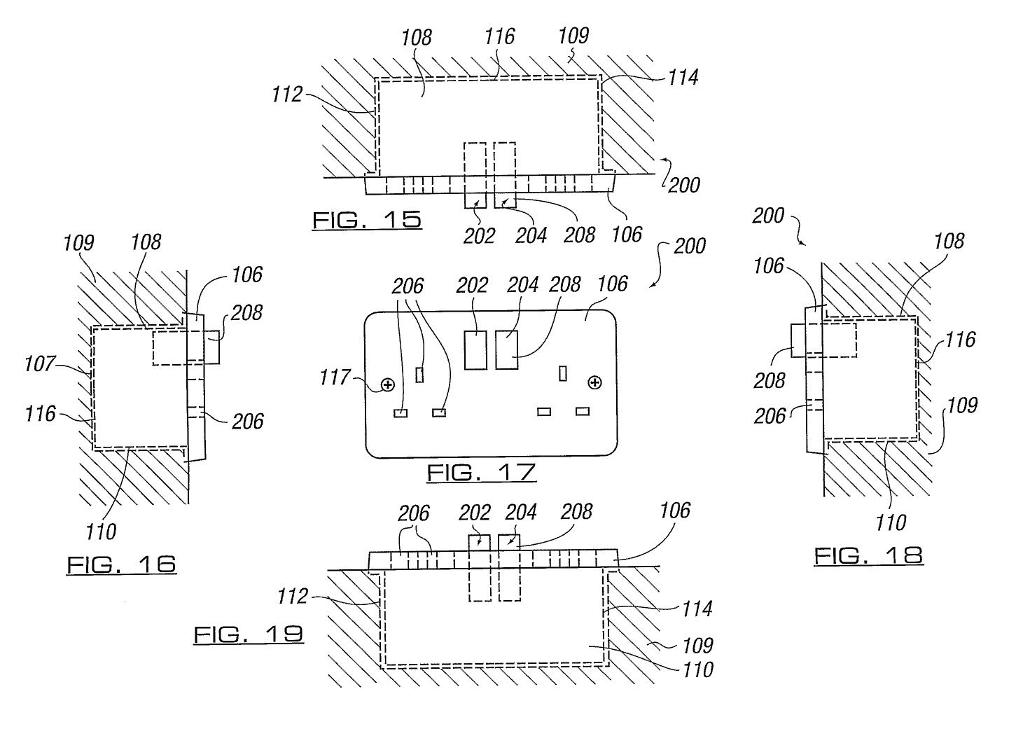

FIGS. 15-19 illustrate a cross sectional view of the electrical socket in FIG. 12a from the top, left side, front view, right side and base respectively;

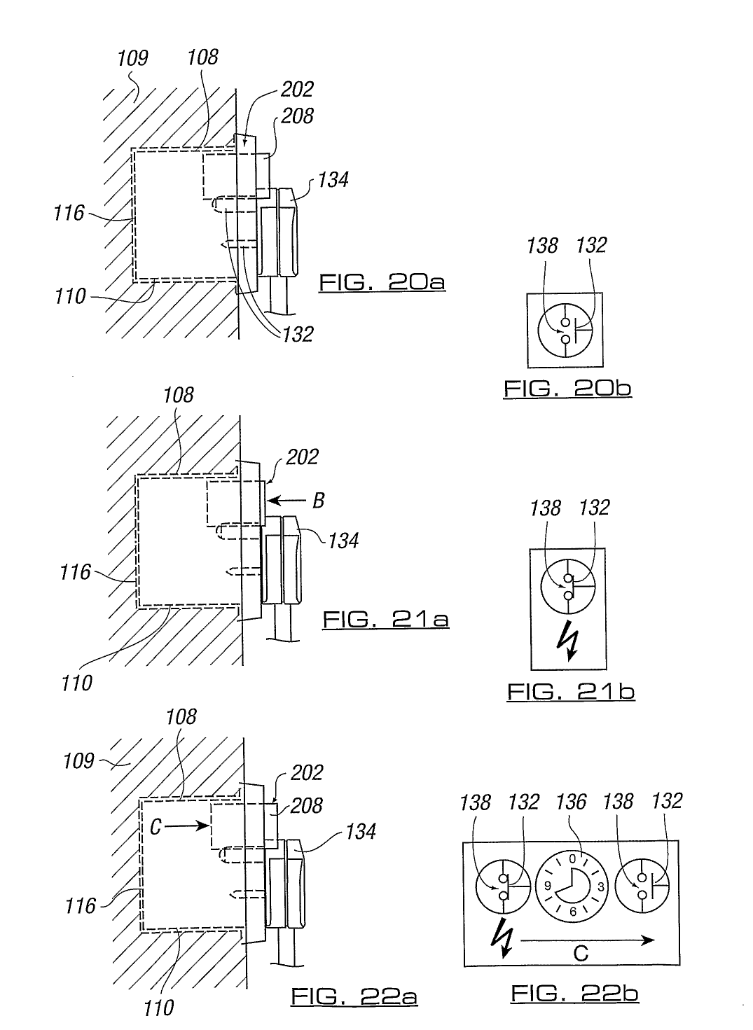

FIG. 20a illustrates a cross sectional view of the side of the electrical socket in FIG. 12a with an electrical plug engaged therewith in use;

FIG. 20b is a schematic view of the electrical connection of the embodiment in FIG. 20a;

FIG. 21a illustrates a cross sectional view of the side of the electrical socket in FIG. 20a with the socket in an actuated position;

FIG. 21b is a schematic view of the electrical connection of the embodiment in FIG. 21a;

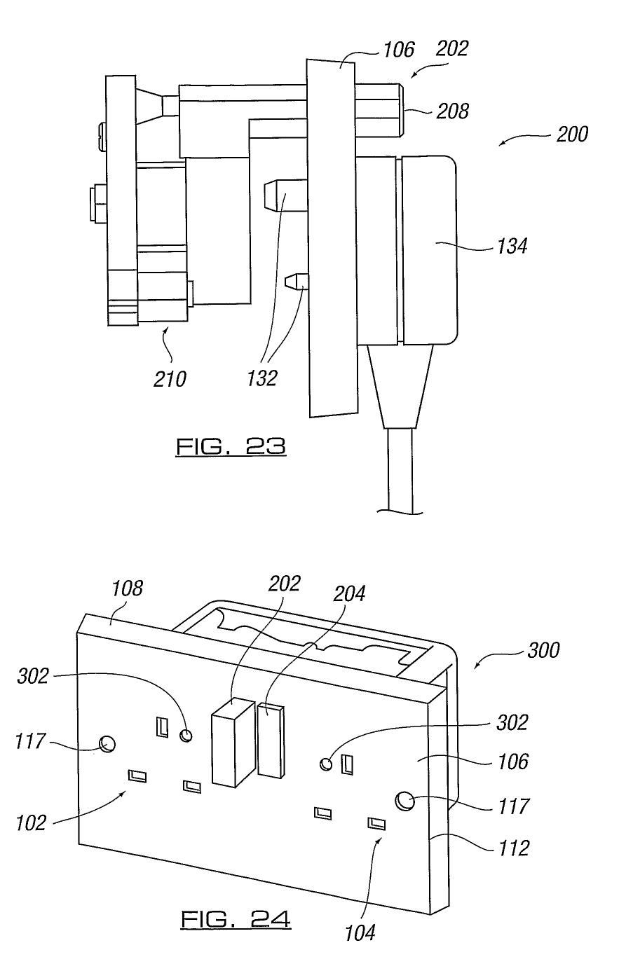

FIG. 22a illustrates a cross sectional view of the side of the electrical socket in FIG. 21a following actuation;

FIG. 22b is a schematic view of the electrical connection of the embodiment in FIG. 22a;

FIG. 23 is a cross sectional view taken through part of the socket in FIGS. 12a-22a in one embodiment;

FIG. 24 is a front perspective view of a further embodiment of the wall socket of the present invention;

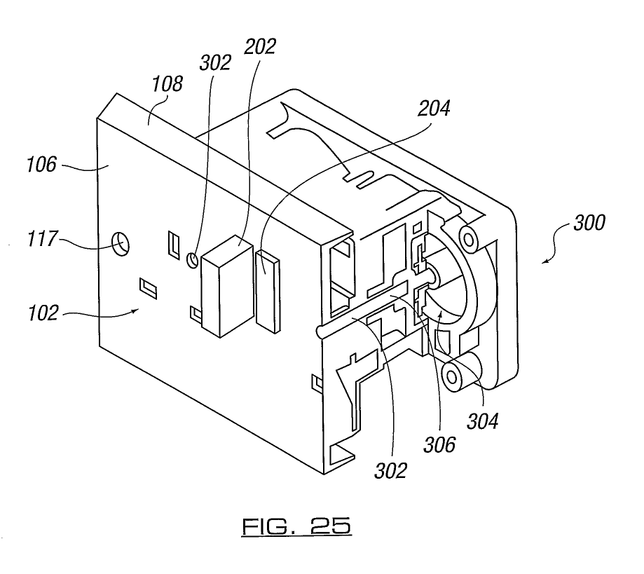

FIG. 25 is a partial cross sectional view taken through the wall socket in FIG. 24.

Referring to the FIGS. 1-11b, there is illustrated a double electrical wall socket 100 having two socket connection means 102, 104 defined in a front face 106 of the socket. The electrical socket 100 has a timing mechanism associated therewith to allow an electrical current to be accessible/supplied via the electrical socket for a pre-determined period of time during use of the socket. This ensures that an electrical item of apparatus plugged into the electrical socket can only be used for said pre-determined period of time without the timing mechanism being reset.

The front face 106 of the socket forms part of a housing of the wall socket, which also includes a top wall 108, base wall 110, end walls 112, 114 and rear wall 116. The housing is located in a recess 107 defined in a wall 109 in use, with the front face 106 of the socket protruding from a front surface of the wall or substantially flush therewith.

Top wall 108, base wall 110, end walls 112, 114 and rear wall 116 are typically in the form of a socket box and the front face 106 is attached to the socket box via screws 117.

Control means in the form of two switches 118, 120 are provided on front face 106 for allowing socket connection means 102, 104 respectively to be moved between an “on” condition, wherein electrical current can flow from the socket to a plug when engaged therewith in use, and an “off” condition, wherein electrical current is prevented from flowing from the socket to a plug when engaged therewith.

In accordance with the present invention, the socket connection means 102, 104 each comprises a first part 122, 124 and a second part 126, 128. The second part 126, 128 is slidably mounted with respect to first part 122, 124 in a direction substantially perpendicular to front face 106. Furthermore, the second part 126, 128 is slidably movable from a first position, wherein the second part is substantially recessed within the housing and first part 122, 124; and a second position, wherein at least a section of the second part 126, 128 protrudes outwardly from front surface 106.

The second part 126, 128 has three apertures 130 located at pre-determined spaced distances apart in a front face thereof. The location of apertures 130 substantially correspond to the positions of protruding electrical pins 132 located on the rear of a conventional plug 134.

With the second part 126, 128 in the first actuated position, the electrical pins 132 of a plug 134 are engaged in apertures 130 and the relevant switch 118, 120 in an “on” condition, electrical connection can be made between electrical connections provided in the socket housing and the electrical pins 132. Thus, electrical current is able to flow from an electrical supply, such as a mains electrical supply, into the electrical socket 100 and through electrical pins 132 and into the electrical apparatus to which plug 132 is attached thereto.

With the second part 126, 128 in the second position and the electrical pins 132 of plug 134 are engaged in apertures 130 and the relevant switch 118, 120 is in an “on” condition, electrical connection or the flow of electrical current through the electrical connections is prevented.

Movement means are associated with the second part 126, 128 to allow the second part to move relative to the first part 122, 124 following actuation thereof. In one example the movement means includes resilient biasing means in the form of a compressable spring (not shown). The spring biases the second part 126, 128 to the second position in use.

Timing means 136 are associated with the movement means to allow movement of the second part from the first position to the second position to take a pre-determined period of time (i.e. a pre-determined time period passes from when electrical current flows from electrical socket to the electrical plug to when the flow of current is prevented or stopped). These timing means can include an actual timing device or the timing means can be inherent to the resilient biasing means or movement mechanism (i.e. equate to the time taken for the compressed spring to decompress).

In use of the electrical socket, a user firstly locates electrical pins 132 of plug 134 into the apertures 130 in second part 128, as shown by arrow ‘A’ in FIGS. 1a and 9a. The second part 128 is currently in a second position where a section partially protrudes outwardly from front surface 106. No electrical connection is made between pins 132 and electrical connection 138 provided in the first part 122, 124 with the second part in the second position, as shown in FIGS. 1b and 9b.

The user then actuates the timing mechanism/movement mechanism by applying a force to the plug 124 in a direction substantially perpendicular to front face 106, as shown by arrow ‘B’ in FIGS. 2a and 10a (i.e. towards rear face 116). This moves the second part 128 to the first position, wherein the second part is substantially recessed or flush with front face 106 and electrical connection is made between pins 132 and electrical connection 138, as shown in FIGS. 2b and 10b.

As soon as the timing mechanism/movement mechanism is actuated, the second part 126, 128 moves from the first position to the second position, as shown by arrow ‘C’ in FIGS. 3a and 11a, in a time substantially equal to or greater than a pre-determined time period for which electrical connection is provided by the socket 100, as shown in FIGS. 3b and 11b. Movement of second part 126, 128 in the direction ‘C’ is in a direction substantially opposite to the directions A and/or B (i.e. outwardly and substantially perpendicularly to front face 106).

Sealing means can be associated with the first and/or second, parts to prevent dirt, moisture and/or the like from entering the electrical socket in use.

The electrical socket and the components thereof can be formed from any or any combination of suitable materials, such as rubber, metal, plastic and/or the like.

The electrical socket can have any number of electrical socket connection means provided thereon as required and the electrical socket connection means can have any number of apertures to allow the location of a corresponding number of electrical pins therein.

Referring to the FIGS. 12a-23, there is illustrated a further embodiment of an electrical wall socket 200 according to the present invention. In this embodiment the timing means are associated with the electrical control means in the form of electrical switches 202, 204 provided on the front wall 106 of the socket.

The same reference numerals have been used in FIGS. 12a-23 to denote the same features as in FIGS. 1-11b.

Other than switches 202, 204, the remaining features of socket 200 are mostly conventional. Thus, socket connection means in the form of recesses 206 are defined in front face 106. Recesses 206 are complementary in shape to electrical pins 134 of conventional plug 134. In use, pins 134 are engaged in recesses 206 to form an electrical connection. On actuation of the switch 202, 204 associated with the particular socket, electrical current is allowed to flow from the electrical supply, through the socket and to pins 134 in a conventional manner.

In accordance with the present invention, each electrical switch 202, 204 comprises a first part (located in the cavity of the socket housing and not shown for clarity purposes) and a second part 208. The second part 208 is slidably mounted with respect to the first part in a direction substantially perpendicular to front face 106 (i.e. second part 208 is capable of undergoing reciprocal linear movement). Furthermore, the second part 208, is slidably movable from a first position, wherein the second part is substantially recessed within the socket housing; and a second position, wherein at least a section of the second part 208 protrudes outwardly from front surface 106.

The second part 208 is joined to an electrical connection unit 210. The electrical connection unit 210 is movable with second part 208 to bring connection unit 210 into electrical engagement with electrical pins 132 in the first actuated position. Electrical current can therefore flow from the electrical supply, through electrical connection unit 202 and through pins 132 to the electrical appliance joined to plug 134.

With the second part 208 in the second non-actuated position, as shown in FIG. 23, electrical connection unit 210 is a spaced distance apart from electrical pins 132 of plug 134 and the flow of electrical current through the electrical connections is prevented.

Movement means are associated with the second part 208 to allow the second part to move relative to the first part following actuation thereof. In one example the movement means includes resilient biasing means in the form of a compressable spring (not shown). The spring biases the second part 208 to the second position in use. Alternatively, the movement means can include pneumatic means, hydraulic means, mechanical means and/or the like.

Timing means 136 are associated with the movement means as previously described.

In use of the electrical socket 200, a user firstly locates electrical pins 132 of plug 134 into the recesses 206 of the socket, as shown by arrow ‘A’ in FIGS. 12a and 20a. The second part 208 is currently in a second position where a section partially protrudes outwardly from front surface 106. No electrical connection is made between pins 132 and electrical connection unit 210 provided with second part 206, as shown in FIGS. 12b and 20b.

The user then actuates the timing mechanism/movement mechanism by applying a force to second part 208 of switch 204 in a direction substantially perpendicular to front face 106, as shown by arrow ‘B’ in FIGS. 13a and 21a (i.e. towards rear face 116). This moves the second part 208 to the first position, wherein the front face of second part is substantially recessed or flush with front face 106 and electrical connection unit 210 is brought into electrical contact with pins 132, as shown in FIGS. 13b and 21b.

As soon as the timing mechanism/movement mechanism is actuated, the second part 208 moves from the first position to the second position, as shown by arrow ‘C’ in FIGS. 14a and 22a, in a time substantially equal to or greater than a pre-determined time period for which electrical connection is provided by the socket 100, as shown in FIGS. 14b and 22b. Movement of second part 208 in the direction ‘C’ is in a direction substantially opposite to the directions A and/or B (i.e. outwardly and substantially perpendicularly to front face 106).

Referring to the FIGS. 24-25, there is illustrated a further embodiment of an electrical wall socket 300 according to the present invention. In this embodiment the timing means are associated with the electrical control means in the form of electrical switches 202, 204 as in the previously described embodiment and are provided on the front wall 106 of the socket.

In this embodiment adjustment means in the form of adjustment screws (now shown) are provided in apertures 302 defined in front surface 106 of socket 300 for adjusting the timing mechanism. A user can use a tool, such as a screw driver to engage with a head of the adjustment screw. Rotation of said screw allows the pre-determined time period over which the timing mechanism provides to be increased or decreased accordingly. Thus, the user can arbitrarily select a time period for which they want to timing mechanism to operate for.

A circuit switch 304 is provided which closes an electric circuit between a live socket outlet and a live wire of the mains electrical supply when the switch 204 is actuated and moved to the first position (i.e. inwardly of the housing as shown in FIG. 25). The circuit switch maintains closure of the electrical circuit during movement of the user actuation switch 204 between the first and second positions. The circuit switch breaks or opens the electrical circuits once the second part has reached the final second position.

A chamber 306 is defined in the socket housing and contains air when the user actuation switch 204 is in the second position. On actuation of the switch 204, the air in forced out of chamber 306 via a plunger as switch 204 moves further into the recess defined in the housing to provide the first position. Resilient biasing means in the form of a compression spring (not shown) acts on the plunger to bias the plunger back to the second position from the first position. The spring is compressed on movement of the plunger from the second position to the first position. The spring then gradually uncoils under its inherent resilient bias as the plunger returns to the second position. This creates negative pressure in the air chamber 306. The circuit switch 304 remains on until the plunger returns to the open position.

A further air chamber or variable aperture can be defined in the housing which is in fluid communication with the air chamber 306 to allow air to re-enter chamber 306 as the plunger moves from the first position to the second position. The combination of the passage of air back into chamber 306 and the resilient biasing force of spring 204 provide the pre-determined timing mechanism for which the switch 304 remains in an “on” position to close the electrical circuit.

The interior surface or surfaces of the first and/or second parts can be provided with suitable stop means to limit the movement between the first and second positions. Suitable support means can be defined in the first and/or second parts to provide support of one or more internal components when assembled.

In one example, the timer on the wall socket can be moved to a specific position wherein it functions as a standard wall socket without a timer as a result of the internal timing mechanism being bypassed. For example, if the timer is moved to the left in the above example, the internal electrical timer is bypassed and thus the socket functions as a conventional socket

1. An electrical wall socket, said wall socket including a housing having one or more electrical socket connection means defined thereon to allow engagement with at least one electrical plug therewith in use, and wherein said wall socket is provided with timing means for timing or determining one or more pre-determined time periods, said timing means arranged such that when actuated, the timing means allows electrical current to flow through said electrical socket from an electrical supply and/or from said electrical socket connection means to an electrical plug engaged therewith in use for said one or more pre-determined time periods.

2. An electrical wall socket according to claim 1 wherein the timing means, once actuated, provides operation of the socket for said one or more pre-determined time periods without further user actuation or intervention being required and, once said time period has expired, the timing means automatically moves the socket to an un-operational condition until further actuation of the timing means takes place.

3. An electrical wall socket according to claim 1 wherein the timing means is manually actuatable by a user in use.

4. An electrical wall socket according to claim 1 wherein the timing means is actuatable remotely from the wall socket via remote control means.

5. An electrical wall socket according to claim 1 wherein the timing means is associated with, provided on or forms part of the electrical socket connection means.

6. An electrical wall socket according to claim 1 wherein electrical control means are provided on the electrical wall socket and said timing means is associated with, provided on or forms part of the electrical control means.

7. An electrical wall socket according to claim 1 wherein the timing means is provided on, is associated with or forms part of a housing of the wall socket.

8. An electrical wall socket according to claim 1 wherein the timing means includes at least a first part and a second part, at least one of said parts capable of undergoing relative movement with respect to the other part between a first position, wherein electrical connection can be made between an electrical supply, the electrical socket connection means and/or an electrical plug engaged with the electrical connection means, and a second position, wherein electrical connection between an electrical supply, the electrical socket connection means and/or an electrical plug engaged with the electrical connection means is prevented.

9. An electrical wall socket according to claim 8 wherein the second part is slidably movable relative to said first part in moving between said first and second positions.

10. An electrical wall socket according to claim 8 wherein the second part is arranged to undergo reciprocal and/or substantially linear movement relative to the first part in moving between said first and second positions.

11. An electrical wall socket according to claim 8 wherein the second part is arranged to move in a direction substantially perpendicular to the front surface of the socket housing.

12. An electrical wall socket according to claim 8 wherein the socket includes biasing means for biasing the second part from the first position to the second position.

13. An electrical wall socket according to claim 12 wherein the biasing means includes any or any combination of resilient biasing means, pneumatic means, hydraulic means or mechanical means.

14. An electrical wall socket according to claim 1 wherein movement means are associated with the timing means and said movement means can include any or any combination of biasing means, resilient biasing means, pneumatic means, hydraulic means or mechanical means.

15. An electrical wall socket according to claim 1 wherein the first part is in the form of a housing, sleeve member or channel member and the second part is movably mounted in, on or around said housing, sleeve member or channel member.

16. An electrical wall socket according to claim 1 wherein the first part is integral with, attached to or detachably attached to a housing of the wall socket.

17. An electrical wall socket according to claim 8 wherein the time taken for movement between the at least first and second parts determines or substantially equates to the one or more pre-determined time periods.

18. An electrical wall socket according to claim 1 wherein the one or more pre-determined periods are set by the manufacturer.

19. An electrical wall socket according to claim 1 wherein adjustment means are provided to allow the one or more pre-determined time periods to be selected by a user from a number of possible pre-determined time periods or an arbitrarily selected time period.

20. An electrical wall socket according to claim 19 wherein the adjustment means includes an adjustment screw.

21. An electrical wall socket according to claim 8 wherein one or more electrical contacts can be provided with, comprise or be associated with the first and/or second parts, such that the in the first position, electrical current can flow between the electrical contacts to allow electrical current to flow between an electrical supply, the electrical socket, the electrical socket connection means and/or an electrical plug engaged with the electrical socket connection means, and in the second position, flow of electrical current between the contacts is prevented.

22. An electrical wall socket according to claim 8 wherein one or more electrical contacts can be separate to the first and/or second parts and movement of the first and/or second parts moves the electrical contacts between an engaged or operational condition and a disengaged or non-operational condition.

23. An electrical wall socket according to claim 5 wherein operational means are associated with the timing means for allowing the timing means to move between operational and non-operational conditions.

24. An electrical wall socket according to claim 8 wherein the second part includes one or more apertures or recesses defined therein and an electrical plug connectable to the socket is located in said one or more apertures or recesses in use.

25. An electrical wall socket according to claim 24 wherein actuation of the timing means takes place on engagement of the electrical plug with the second part or, alternatively, further actuation of the timing means may be required by actuating electrical control means associated with the socket and/or applying a further movement force to the electrical plug relative to the electrical socket.

26. An electrical wall socket according to claim 1 wherein written instructions, symbols or arrows are provided on said socket to allow a user to determine how to actuate said socket.

27. An electrical wall socket according to claim 1 wherein sealing means are provided in or on the socket to prevent dirt and/or moisture from entering the socket interior.

28. A method of using an electrical wall socket, said method including the steps of engaging an electrical plug with electrical socket connection means defined on said wall socket, and actuating timing means provided on said wall socket for timing or determining one or more pre-determined time periods, said timing means arranged such that when actuated, the timing means allows electrical current to flow through said electrical socket from an electrical supply and/or from said electrical socket connection means to the electrical plug engaged therewith for said one or more pre-determined time periods.
